(19) United States
(12) Patent Application Publication
(10) Pub. No.: US 2015/0241909 A1
(43) Pub. Date: Aug. 27, 2015

(54) TOUCH PANEL

(71) Applicant: SHARP KABUSHIKI KAISHA, Osaka (JP)

(72) Inventors: Hiroki Makino, Osaka (JP); Mikihiro Noma, Osaka (JP)

(73) Assignee: SHARP KABUSHIKI KAISHA, Osaka (JP)

(21) Appl. No.: 14/433,921

(22) PCT Filed: Oct. 10, 2013
(86) PCT No.: PCT/JP2013/077546

§ 371 Date: Apr. 7, 2015

(30) Foreign Application Priority Data
Oct. 16, 2012 (JP) 2012-228912

(51) Int. Cl. G06F 1/16; G06F 3/041

(52) U.S. Cl. CPC G06F 1/16; G06F 3/041; G06F 2203/04107

(57) ABSTRACT

Provided is a touch panel provided with an active area where touch input is performed, including: a tempered glass substrate having a compressive stress layer on surfaces thereof; and transparent electrodes made of an inorganic oxide film formed on the active area of the tempered glass substrate. A foundation layer made of an organic film is disposed between the transparent electrodes and the compressive stress layer, which prevents the transparent electrodes and the compressive stress layer thereunder from contacting each other.

### TECHNICAL FIELD

The present invention relates to a touch panel.

This application claims priority on the basis of Japanese Patent Application No. 2012-228912 filed Oct. 16, 2012, the entire contents of which are incorporated herein by reference.

### BACKGROUND ART

In terms of display devices with a touch input function, devices in which a touch panel is adhered to the surface of a liquid crystal panel are known (see Patent Document 1). To increase mechanical strength, devices with a cover glass disposed on the surface of a touch panel are also known; however, to make a device thinner and more lightweight, a device with a touch sensor formed on a surface of a substrate made of a tempered glass (hereinafter referred to as “tempered glass substrate”), and in which a cover glass is eliminated has been proposed (see Patent Document 2).

### RELATED ART DOCUMENTS

### Patent Documents

Patent Document 1: Japanese Patent Application Laid-Open Publication No. 2007-304390

Patent Document 2: Japanese Patent Application Laid-Open Publication No. 2011-197709

### SUMMARY OF THE INVENTION

### Problems to be Solved by the Invention

A tempered glass substrate has a compressive stress layer formed on the surfaces thereof by an ion exchange method, a tempering method with air blast quenching, or the like, and has a higher mechanical strength than a conventional glass substrate. A touch sensor is made by forming, on the surface of the tempered glass substrate (surface of a compressive stress layer), an inorganic transparent electrode that detects the input position or an interlayer insulating film.

However, observations by the present inventors revealed that by forming a touch sensor on a surface of a tempered glass substrate, the values of a surface impact test or glass surface strength measurement decrease significantly compared to values that a tempered glass substrate normally indicate due to ion exchange, or the like. Therefore, even with a load that is below the normal impact resistance strength, the tempered glass substrate broke, and there was a problem of not having enough mechanical strength.

The purpose of the present invention is to provide a touch panel with excellent mechanical strength.

### Means for Solving the Problems

A touch panel of present invention is a touch panel having an active area where touch input is performed, including: a tempered glass substrate formed with a compressive stress layer on a surface thereof; and transparent electrodes including an inorganic oxide film formed on the tempered glass substrate in the active area, wherein a foundation layer including an organic film is disposed between the transparent electrodes and the compressive stress layer thereunder, and wherein the transparent electrodes and the compressive stress layer thereunder are not in contact with each other by virtue of the foundation layer being interposed therebetween.

A panel peripheral section may be disposed in a periphery of the active area; a wiring may be formed in the panel peripheral section and may include an inorganic film, the wiring being connected to the transparent electrodes; and a light shielding layer may be disposed between the wiring and the compressive stress layer and may include an organic film.

The foundation layer may be formed on both the active area and the panel peripheral section, and the light shielding layer and the foundation layer may be provided between the wiring and the compressive stress layer.

### Effects of the Invention

According to the present invention, a touch panel with excellent mechanical strength can be provided.

### BRIEF DESCRIPTION OF THE DRAWINGS

FIG. 1 is a plan view of a touch panel according to Embodiment 1.

FIG. 2 is a cross-sectional view of a touch panel along the line A-A′ in FIG. 1.

FIG. 3 shows a method of a touch panel impact test.

FIG. 4 shows the results of a touch panel impact test.

FIG. 5A shows the crack generation mechanism of a tempered glass substrate from observations of the impact test results in FIG. 4.

FIG. 5B shows the crack generation mechanism of a tempered glass substrate from observations of the impact test results in FIG. 4.

FIG. 5C shows the crack generation mechanism of a tempered glass substrate from observations of the impact test results in FIG. 4.

FIG. 6 is a cross-sectional view of a touch panel according to Embodiment 2.

FIG. 7 is a cross-sectional view of a touch panel according to Embodiment 3.

### DETAILED DESCRIPTION OF EMBODIMENTS

### Embodiment 1

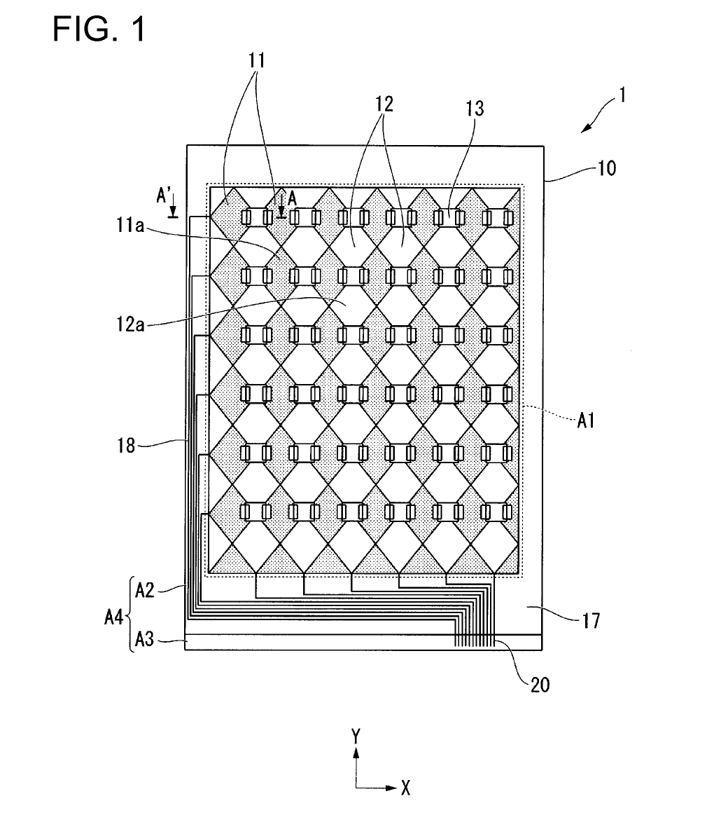

FIG. 1 is a plan view of a touch panel 1 according to Embodiment 1.

In the present embodiment, the outer shape of the touch panel 1 is a rectangular shape, the direction parallel to a side of the touch panel is defined as the x-direction, and the direction perpendicular to the side is defined as the y-direction.

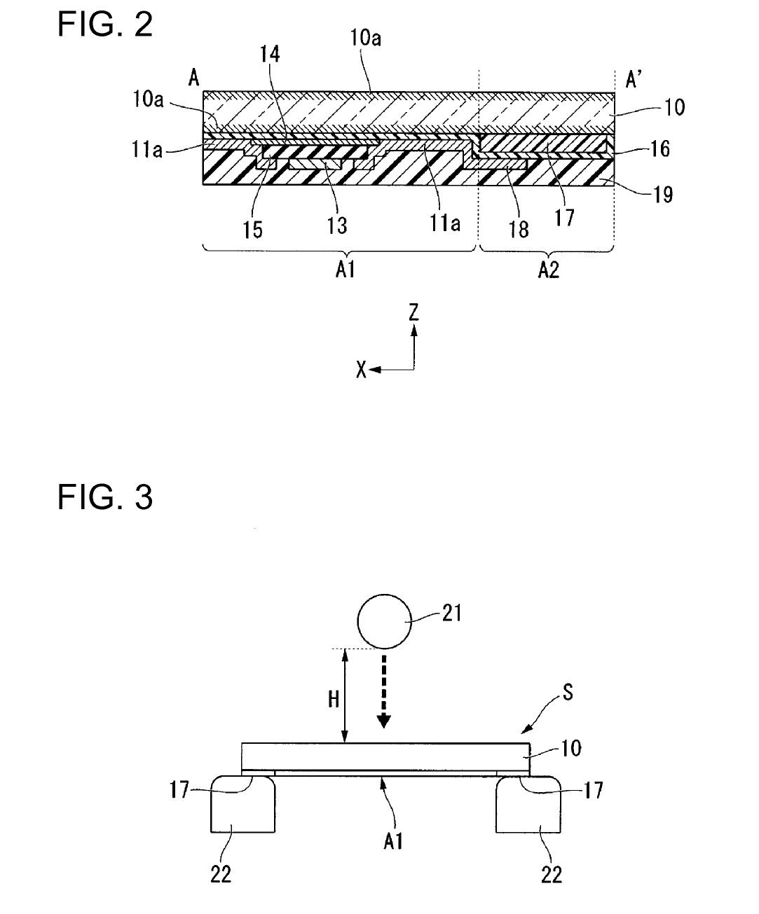

The touch panel 1 is a cover glass-integrated touch panel with a touch sensor formed on a tempered glass substrate 10. A compressive stress layer 10a (see FIG. 2) is formed on the surface of the tempered glass substrate 10 by an ion exchange method, a tempering method using air blast quenching, or the like. The present embodiment uses a glass substrate in which the compressive stress has been generated by chemically substituting an alkali element contained on the outermost surface of a glass substrate with an element with a larger ionic radius than the alkali element, for example. The thickness of the tempered glass substrate 10 is 0.5 mm to 1.1 mm, for example. The tempered glass substrate 10 thus formed is provided with a breaking strength of about 3 to 5 times that of an alkali-free glass substrate used in liquid crystal panels.

The tempered glass substrate 10 is provided with a plurality of first electrodes 11 extending in an x-direction and a plurality of second electrodes 12 extending in a y-direction. The first electrodes 11 are formed by connecting a plurality of diamond-shaped electrodes 11a in the x-direction by a connecting part 14 (see FIG. 2). The second electrodes 12 are formed by connecting a plurality of diamond-shaped electrodes 12a in the y-direction by a connecting part 13. The first electrodes 11 (diamond shaped electrode 11a, connecting part 14) and the second electrodes 12 (diamond-shaped electrode 12a, connecting part 13) are transparent electrodes made of an inorganic oxide film such as indium tin oxide (ITO).

The capacitive touch sensor is formed of the first electrodes 11 and the second electrodes 12. The touch panel 1 detects the size of parasitic capacitance of each intersection between the first electrodes 11 and the second electrodes 12 on the basis of the distortion of the signal waveform supplied to the first electrodes 11 and the second electrodes 12. Thereafter, the touch panel detects the position of the conducting member (a finger or a pen, for example) carrying out the touch input on the basis of the change in parasitic capacitance.

The center section of the tempered glass substrate 10 is provided with an active area A1 where touch input is carried out. The peripheral section of the active area A1 is provided with a panel peripheral section A4. The panel peripheral section A4 includes: a wiring forming section A2 where the wiring 18 that connects to the first electrodes 11 and the second electrodes 12 is formed; and a terminal section A3 where terminals 20 connected to the wiring 18 is formed. A flexible wiring substrate (not shown) is connected to the terminal section A3. A rectangular, frame-shaped light shielding layer 17 is formed on the wiring forming section A2 so as to border the active area A1.

FIG. 2 is a cross-sectional view of a touch panel 1 along the line A-A′ in FIG. 1.

A compressive stress layer 10a is formed on the front surface and the back surface of the tempered glass substrate 10. The light shielding layer 17 made of an organic film such as a black photosensitive resin is formed on the compressive stress layer 10a on one surface of the tempered glass substrate 10 in a position corresponding to the wiring forming section A2.

A foundation layer 16 made of an organic film such as a transparent photosensitive resin is formed on one surface of the tempered glass substrate 10 and covers the compressive stress layer 10a and the light shielding layer 17. The connecting part 14 made of an inorganic oxide film such as ITO is formed on the surface of the foundation layer 16 of the active area A1 at corresponding intersections of the first electrodes and the second electrodes. An insulating layer 15 with an area smaller than that of the connecting part 14 is formed on the surface of the connecting part 14.

The diamond-shaped electrodes 11a and the diamond-shaped electrodes 12a (see FIG. 1) are formed on the surface of the foundation layer 16 so as to cover the portion exposed from the insulating layer 15 of the connecting part 14. The diamond-shaped electrodes 11a and the diamond-shaped electrodes 12a are formed so a part thereof runs on the periphery of the insulating layer 15. The connecting part 13 is formed on the surface of the insulating layer 15.

The foundation layer 17 and the wiring 18 are laminated in this order on the surface of the light shielding layer 17 formed in the wiring forming section A2. The wiring 18 is connected to the diamond-shaped electrodes 11a that are formed on the outermost periphery of the active area A1. In the case of the present embodiment, the wiring 18 is integrally formed with the diamond-shaped electrodes 11a by an inorganic oxide film such as ITO, for example; however, the material of the wiring 18 is not limited thereto. The wiring 18 may be formed of other inorganic films such as silver or aluminum.

An overcoat layer 19 made of a transparent resin such as acrylic is formed on one surface of the tempered glass substrate 10, and covers the foundation layer 16, the diamond-shaped electrodes 11a and 12a, the connecting part 13, and the insulating layer 15.

The foundation layer 16 may be formed on at least the portion of the active area A1 where the diamond-shaped electrodes 11a and 12a are formed; however, in the present embodiment, in order to avoid the trouble of patterning, the foundation layer 16 is formed on the entire surface of the tempered glass substrate 10. In other words, the foundation layer 16 is formed on both the active area A1 and the panel peripheral section A4.

In the above-mentioned configuration of the touch panel 1, the diamond-shaped electrodes 11a and 12a made of an inorganic oxide film are formed on the surface of the foundation layer 16 made of an organic film. The diamond-shaped electrodes 11a and 12a and the compressive stress layer 10a, with the foundation layer 16 sandwiched therebetween, are configured so as to not come into contact with each other. Therefore, the influence of a crack that occurs on the diamond-shaped electrodes 11a and 12a when a mechanical shock is applied to the active area A1 does not directly affect the compressive stress layer 10a of the tempered glass substrate 10. The foundation layer 16, which is more flexible than the diamond-shaped electrodes 11a and 12a, serves the role of a cushioning material, making it possible for the mechanical strength inherent in the tempered glass substrate 10 to be effectively demonstrated.

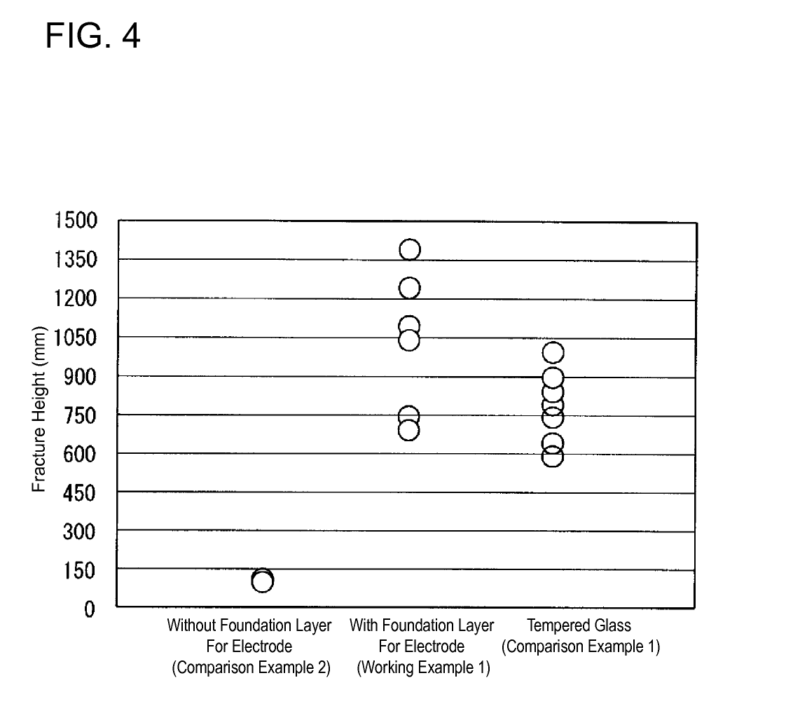

The effects of the foundation layer 16 will be explained below using FIG. 3 and FIG. 4.

FIG. 3 shows the method of the touch panel S impact test. FIG. 4 shows the results of the touch panel S impact test.

As shown in FIG. 3, the impact test of the touch panel S was performed by dropping a weight 21 with a prescribed weight from the back surface side of the touch panel S (the side in which the touch sensor is not formed) on top of the active area A1, under a condition in which the periphery of the touch panel S is supported by support bases 22.

The height H from the touch panel S to the weight 21 can be changed between 0 mm to 1500 mm. The load resistance properties of the touch panel S are measured, with the fracture height set as the height H of the weight 21 when a crack occurs on the tempered glass substrate 10.

The “tempered glass” in FIG. 4 shows a situation when a touch sensor is not formed on the surface of a tempered glass substrate 10 (Comparison Example 1). “Without Foundation Layer For Electrode” shows a situation when a foundation layer made of an organic film is not formed between a compressive stress layer and a diamond-shaped electrode of a tempered glass substrate 10 (Comparison Example 2). “With Foundation Layer For Electrode” shows a situation when a foundation layer made of an organic film is formed between a compressive stress layer and a diamond-shaped electrode of a tempered glass substrate 10 (Embodiment Example 1). The thickness of the tempered glass substrate 10 is 5.5 mm in any of the situations of Comparison Example 1, Comparison Example 2, and Working Example 1.

A plurality of samples with the same configuration were prepared for each situation of Comparison Example 1, Comparison Example 2, and Working Example 1, and the same test was conducted for each sample. Although variations in the measurement results occur in Comparison Example 1 and Working Example 1, the measurement results show a clear trend.

That is, although the fracture height H of the configuration with only the tempered glass substrate (Comparison Example 1) is at least 600 mm, in the configuration in which a touch sensor is formed on the surface of the tempered glass substrate without providing a foundation layer (Comparison Example 2), the fracture height H thereof is below 150 mm, and the load resistance properties are worse than that of the configuration with only the tempered glass substrate. On the other hand, in the configuration in which a touch sensor is formed and a foundation layer is provided on the surface of the tempered glass substrate (Working Example 1), the fracture height H thereof surpasses 600 mm, and compared to the average fracture height H, the load resistance properties are improved compared to the configuration with only the tempered glass substrate (Comparison Example 1).

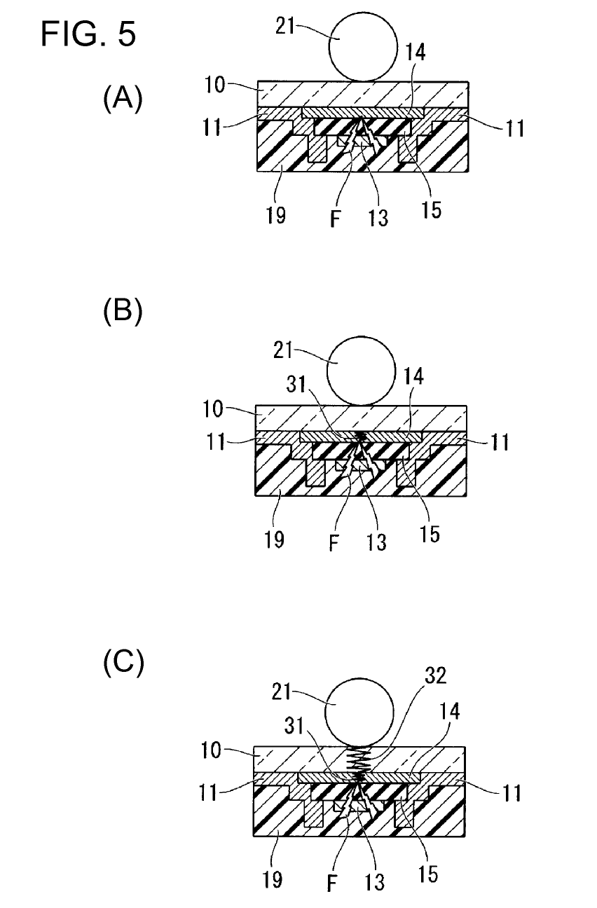

FIG. 5A to FIG. 5C show the crack generation mechanism of a tempered glass substrate considered from the impact test results in FIG. 4. FIG. 5A to FIG. 5C show the crack generation mechanism when a foundation layer is not provided on the surface of the tempered glass substrate 10 (Comparison Example 2).

As shown in FIG. 5A, when a weight 21 collides with the tempered glass substrate 10, tensile stress F is generated on the transparent electrodes (connecting part 14 or diamond-shaped electrode 11a, for example) on the surface of the tempered glass substrate 10 due to the bend in the tempered glass substrate 10. Transparent electrodes 14 and 11a are extremely thin with a thickness from 0.03 μm to 0.05 μm, and as an inorganic material, have high rigidity. Therefore, as shown in FIG. 5B, when a significant tensile stress F is applied instantaneously due to a collision of the weight 21, a crack 31 is more likely to be generated on the transparent electrodes 14 and 11a.

As shown in FIG. 5C, when the tempered glass substrate 10 and the transparent electrodes 14 and 11a are in direct contact, a fine crack 31 on the transparent electrodes 14 and 11a affects the surface of the tempered glass substrate 10 (compressive stress layer). A compressive stress of about 600 MPa to 700 MPa is normally applied to the surface of the tempered glass substrate 10 in order to provide resistance properties against scratches and pulling; however, when a large force (tensile stress) is generated instantaneously on the surface of the tempered glass substrate 10 due the elongation of a fine crack 31 that occurs on the transparent electrodes 14 and 11a, the force thereof also generates a crack 32 on the surface of the tempered glass substrate 10, becoming the cause of a break.

When considering the above-mentioned cause of a break on the tempered glass substrate 10, providing a flexible foundation layer 16 (see FIG. 2) that serves as a cushioning material between the tempered glass substrate 10 and the transparent electrodes 14 and 11a as a way to prevent a break on the tempered glass substrate 10, was found to be effective. The foundation layer 16 suppresses the tensile stress of a fine crack generated on the transparent electrodes 14 and 11a from being transmitted to the compressive stress layer 10a (see FIG. 2) of the tempered glass substrate 10. In this way, the mechanical strength inherent to the compressive stress layer 10a can be fully displayed.

The validity of the above-mentioned mechanism is supported by the results of the impact test of FIG. 4. The present inventors devised the present invention on the basis of such findings, and the remarkably excellent effects thereof have been experimentally verified. According to the present invention, mechanical strength that can withstand practical use can be easily achieved with a simple configuration of simply providing a foundation layer.

The touch panel 1 according to this embodiment, as mentioned above, is provided with a foundation layer 16 made of an organic film disposed between the compressive stress layer 10a and the transparent electrodes 11a, 12a, and 14, and the compressive stress layer 10 and the transparent electrodes 11a, 12a, and 14, with the foundation layer 16 sandwiched therebetween, are configured so as to not come into contact with each other. Therefore, a touch panel 1 that is thin, lightweight, and has excellent mechanical strength can be provided.

Further, the touch panel 1 of this embodiment is provided with the foundation layer 16 made of an organic film and the light shielding layer 17 made of an organic film, which are disposed between the wiring 18 and the compressive stress layer 10a, and the wiring 18 and the compressive stress layer 10a, with the foundation layer 16 and the light shielding layer 17 sandwiched therebetween, are configured so as to not come in contact with each other. Therefore, even if a crack occurs on the wiring 18, the tensile stress of the crack is prevented from transmitting directly to the compressive stress layer 10a by the light shielding layer 17 and the foundation layer 16, which is more flexible than the wiring 18. Therefore, fractures on the wiring forming section A2 of the tempered glass substrate 10 are prevented. In the same manner, for terminal section A3, since the foundation layer 16 is formed between the terminal 20 and the compressive stress layer 10a, fractures are prevented from occurring on the tempered glass substrate 10 from a crack that has occurred on the terminal 20.

### Embodiment 2

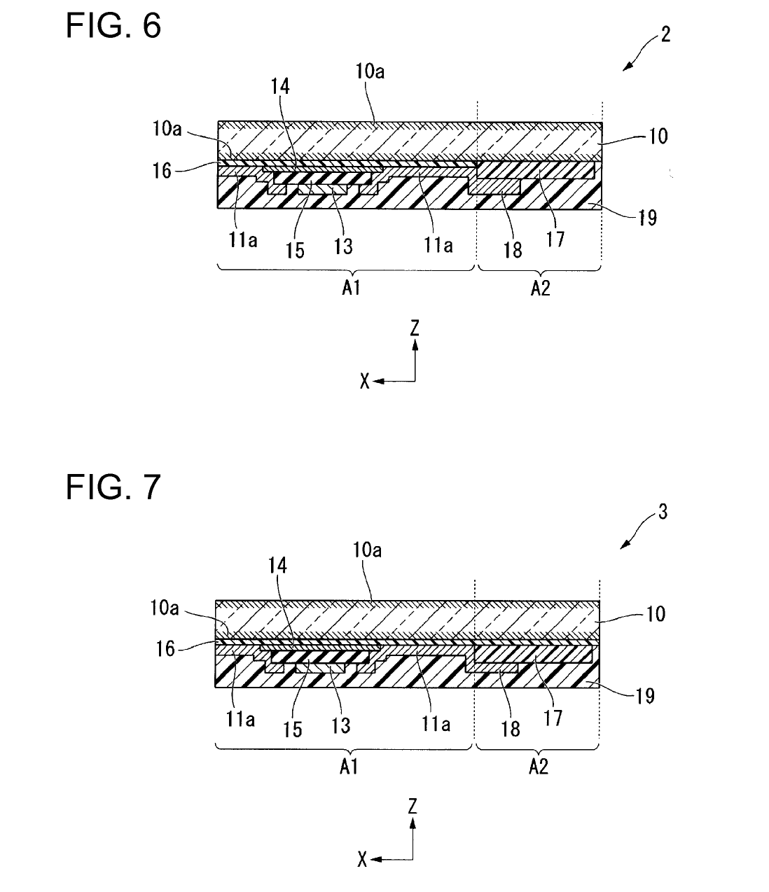

FIG. 6 is a cross-sectional view of a touch panel 2 according to Embodiment 2.

In the present embodiment, the same components as those in the Embodiment 1 are given the same reference characters, and the description thereof will not be repeated.

The features of this embodiment that differ from the Embodiment 1 are that the foundation layer 18 is selectively formed in the active area A1, and the light shielding layer 17 is exposed from the foundation layer 16, and that the wiring 18 is formed on the light shielding layer 17 on the portion that is exposed from the foundation layer 16.

The configuration thereof can provide a touch panel 2 that has excellent mechanical strength, and prevents cracks in the active area A1 and the wiring forming section A2 of the tempered glass substrate 10.

### Embodiment 3

FIG. 7 is a cross-sectional view of the touch panel 3 according to Embodiment 3.

In the present embodiment, the same components as those in the Embodiment 1 are given the same reference characters, and the description thereof will not be repeated.

Features in the present embodiment that are different from Embodiment 1 are that the light shielding layer 17 is formed on the surface of the foundation layer 16, and that the wiring 18 is formed on the surface of the light shielding layer 17. In Embodiment 1, between the compressive stress layer 10a and the wiring 18, the light shielding layer 17 and the foundation layer 16 are laminated in this order on the side of the compressive stress layer 10a. However, in this embodiment, between the compressive stress layer 10a and the wiring 18, the foundation layer 16 and the light shielding layer 17 are multilayered in this order on the side of the compressive stress layer 10a. The feature in which the foundation layer 16 is formed on the entire surface of the tempered glass substrate 10 is the same as Embodiment 1.

The above configuration also prevents fractures in the active area A1, the wiring forming section A2, and the terminal section A3 (see FIG. 1) of the tempered glass substrate 10, and a touch panel 3 with excellent mechanical strength can be provided.

### Industrial Applicability

The present invention can be used in a touch panel.

### Description of Reference Characters

1, 2, 3 touch panel

10 tempered glass substrate

11 first electrode (transparent electrode)

11a diamond-shaped electrode (transparent electrode)

12 second electrode (transparent electrode)

12a diamond-shaped electrode (transparent electrode)

13 connecting part (transparent electrode)

14 connecting part (transparent electrode)

16 foundation layer

17 light shielding layer

18 wiring

A1 active area

A4 panel peripheral section

1. A touch panel having an active area where touch input is performed, comprising:
a tempered glass substrate formed with a compressive stress layer on a surface thereof; and
transparent electrodes comprising an inorganic oxide film formed on the tempered glass substrate in said active area,
wherein a foundation layer comprising an organic film is disposed between said transparent electrodes and the compressive stress layer thereunder, and
wherein said transparent electrodes and said compressive stress layer thereunder are not in contact with each other by virtue of said foundation layer being interposed therebetween.

2. The touch panel according to claim 1, further comprising:
a panel peripheral section disposed in a periphery of said active area;
a wiring formed in said panel peripheral section and comprising an inorganic film, said wiring being connected to said transparent electrodes; and
a light shielding layer disposed between said wiring and said compressive stress layer and comprising an organic film.

3. The touch panel according to claim 2,
wherein said foundation layer is formed on both said active area and said panel peripheral section, and
wherein said light shielding layer and said foundation layer are provided between said wiring and said compressive stress layer.
